(19) United States
(12) Patent Application Publication
(10) Pub. No.: US 2026/0279854 A1
(43) Pub. Date: Sep. 17, 2026

(54) OPERATING METHOD FOR PREVENTING ANODE DEPLETION WHEN OPERATING A FUEL CELL SYSTEM

(71) Applicant: Robert Bosch GmbH, Stuttgart (DE)

(72) Inventors: Jonas Breitinger, Stuttgart (DE); Mark Hellmann, Korntal (DE)

(21) Appl. No.: 19/479,826

(22) PCT Filed: Apr. 26, 2024
(86) PCT No.: PCT/EP2024/061545

§ 371 Date: Oct. 29, 2025

(30) Foreign Application Priority Data
May 3, 2023 (DE) 10 2023 204 074.3

(51) Int. Cl. H01M 8/04089

(52) U.S. Cl. CPC H01M 8/04104

(57) ABSTRACT

The invention presented relates to an operating method (100) for preventing anode depletion when operating a fuel cell system (200) wherein:
on the basis of a change in an electric current which is provided by the fuel system (200) in order to set a load demand that is reduced in comparison to a currently set load demand, a threshold for a characteristic value of an operating variable of the fuel cell system (200) is determined, and
if the characteristic value reaches the threshold, the hydrogen content in an anode subsystem (203) of the fuel cell system (200) is increased.

### BACKGROUND

The presented invention relates to an operating method for preventing anode depletion when operating a fuel cell system and a fuel cell system.

Hydrogen-based polymer electrolyte membrane fuel cells are regarded as the mobility concept of the future, as they only emit water as exhaust gas, and enable fast refueling times.

When a fuel cell system is operated, inert gases (nitrogen, water vapor) accumulate in the hydrogen system. These inert gases displace the hydrogen and/or lower the hydrogen concentration, which can degrade performance, in particular a cell voltage of the fuel cell system, or cause degradation due to hydrogen depletion.

In order to avoid these negative effects, it is known to regularly flush or “purge” the hydrogen system or the anode subsystem. When a purge valve is opened, a portion of the hydrogen gas mixture escapes from the hydrogen system and is typically mixed into the exhaust conduit of the air system downstream of the cathode.

For controlling or regulating the purge valve, numerous methods are known, but they do not prevent hydrogen depletion during large load jumps.

### SUMMARY

In the context of the invention presented, a method for operating the fuel cell system and a fuel cell system are presented. Further features and details of the invention may be derived from the respective subordinate claims, the description, and the drawings. Features and details described in connection with the method according to the invention naturally also apply in connection with the fuel cell system according to the invention, and vice versa, respectively, such that reference is or may be made mutually with respect to the disclosure of the individual aspects of the invention.

In particular, the invention presented serves to provide a means of preventing hydrogen depletion during large load jumps.

Therefore, according to a first aspect of the invention presented, an operating method for preventing anode depletion when operating a fuel cell system is presented.

The presented operating method provides that a threshold for a characteristic value of an operating variable of the fuel cell system is determined on the basis of a change in an electric current which is provided in order to set a load demand that is reduced in comparison to a currently set load demand, and if the characteristic value reaches the threshold, the hydrogen content in an anode subsystem of the fuel cell system is increased.

In the context of the invention presented, anode depletion means a condition of a fuel cell system in which a hydrogen concentration in the anode subsystem of the fuel cell system falls below a critical threshold so that degradation and/or a drop in performance may occur.

In the context of the present method, a curve of a parameter that changes in the operation of the fuel cell system, in particular an electric current provided by the fuel cell system or a hydrogen system or an air system of the fuel cell system.

A reduced load demand versus a currently set load demand may be predetermined or provided, for example, in response to an instruction, such as an instruction provided by a user or an automatic control system, in order to reduce a current set load demand. Such an instruction may be provided by a driver of a vehicle, for example, by reducing a pressure to a gas pedal of a vehicle driven by the presented fuel cell system. Alternatively, such an instruction may be provided, for example, by a control device for controlling a vehicle driven by the presented fuel cell system, i.e., transmitted to the computing unit of the presented fuel cell system.

The operating method presented is based on a detection step for detecting occurrence of a state, in which anode depletion typically occurs. According to the present invention, an electric current supplied by the fuel cell system in response to a changed load demand is analyzed for this purpose. For example, it can be detected whether the electric current shows a particularly steep load gradient or a particularly high step height, which typically cause a state of anode depletion.

When such a state, in which anode depletion typically occurs, is detected, a threshold or threshold value is dynamically detected, above which threshold hydrogen concentration in the anode subsystem is increased, that is, by adjusting the fuel cell system.

To dynamically determine the threshold, a change in an electric current provided to set a reduced load demand is analyzed. For this purpose, a gradient or an absolute step height of the change can be analyzed, for example, and a corresponding threshold can be assigned to the change, for example, using a mapping scheme.

In the event that it is necessary for the hydrogen content in the anode subsystem to be increased or a respective operating variable reaches the threshold, the fuel cell system can be adjusted, in particular by controlling a purge valve and/or a hydrogen metering valve to supply hydrogen to the anode subsystem of the fuel cell system, in order to prioritize a concentration, a partial pressure or an absolute amount of hydrogen in the anode subsystem over other control targets.

It is conceivable that the change in the electric current, which is provided in order to set the reduced load demand, is determined based on a change in the electric current over time and/or an absolute change in the strength of the electric current.

In particular, a change over time, i.e., a gradient in [A/s], of the electric current supplied by a fuel cell system, has been found to be a reliable measure of detecting anode depletion.

It is further conceivable that the threshold has a negative value, a positive value, or is formulated as an amount.

Depending on the type of the determined characteristic value, the threshold can be selected accordingly so that, for example, small load shedding can be differentiated from large load shedding and only large load shedding can initiate supply or accumulation of hydrogen in the anode subsystem.

Accordingly, a threshold in the context of the invention presented should be understood to mean an operation, in which a determined operating variable such as a load gradient, assumes a value that is above or below a threshold, in particular less than a negative threshold.

It is further conceivable that the characteristic value comprises a change in the electric current over time, a change in a pressure in a hydrogen system of the fuel cell system over time, and/or a change in a pressure in an air system of the fuel cell system over time.

Both changes in the air system and changes in the hydrogen system or in the supplied electric current may indicate anode depletion.

It is further conceivable that the hydrogen content in the anode subsystem of the fuel cell system is increased by metering hydrogen into the anode system by way of a hydrogen metering valve and a purge valve is opened for releasing gas from the anode subsystem and/or an electric load of the fuel cell system is reduced, and/or a drop in a pressure in a cathode subsystem of the fuel cell system is delayed.

By opening the purge valve to release gas from the anode subsystem, pressure in the anode subsystem may be reduced, thereby allowing hydrogen to be supplied through a hydrogen metering valve. It is particularly conceivable that the hydrogen content in the anode subsystem of the fuel cell system is increased by closing a recirculation valve of the fuel cell system.

By reducing the electrical load up to the point of complete load shedding, a lower minimum hydrogen partial pressure is required so that the required supply of hydrogen is minimized.

By delaying a decrease in a pressure in a cathode subsystem of a fuel cell system, pressure reduction in the anode subsystem may be optimized for efficiency without opening the purge valve.

It is further conceivable that the hydrogen content in the anode subsystem is reduced back to a predetermined normal value if any of the following conditions occur:
since increasing the hydrogen content in the anode subsystem, a predetermined time has passed,
to increase the hydrogen content in the anode subsystem, a predetermined minimum amount of hydrogen was metered,
a hydrogen partial pressure in the anode subsystem is above a predetermined hydrogen partial pressure threshold.

It is conceivable that the hydrogen partial pressure in the anode subsystem is estimated using a mathematical model.

A mathematical model allows an inexpensive sensor technology to be omitted.

According to a second aspect, the invention presented here relates to a fuel cell system for converting energy.

The presented fuel cell system comprises a fuel cell stack and a computing unit, wherein the computing unit is configured to perform a possible embodiment of the presented operating method.

In particular, it is conceivable that the computing unit is configured to determine a threshold for a characteristic value of an operating variable of the fuel cell system on the basis of a change in an electric current which is provided in order to set a load demand that is reduced in comparison to a currently set load demand, and if the characteristic value reaches the threshold, to increase the hydrogen content in an anode subsystem of the fuel cell system.

All advantages described in detail to the operating method for preventing anode depletion when operating a fuel cell system according to the first aspect of the invention apply equally to the fuel cell system for converting energy according to the second aspect of the invention.

### BRIEF DESCRIPTION OF THE DRAWINGS

Further advantages, features, and details of the invention arise from the following description, in which exemplary embodiments of the invention are described in detail with reference to the drawings. In this context, the features mentioned in the claims and in the description may each be essential to the invention individually or in any combination.

The figures show:

FIG. 1 a possible embodiment of the presented operating method,

FIG. 2 a possible embodiment of the presented fuel cell system.

### DETAILED DESCRIPTION

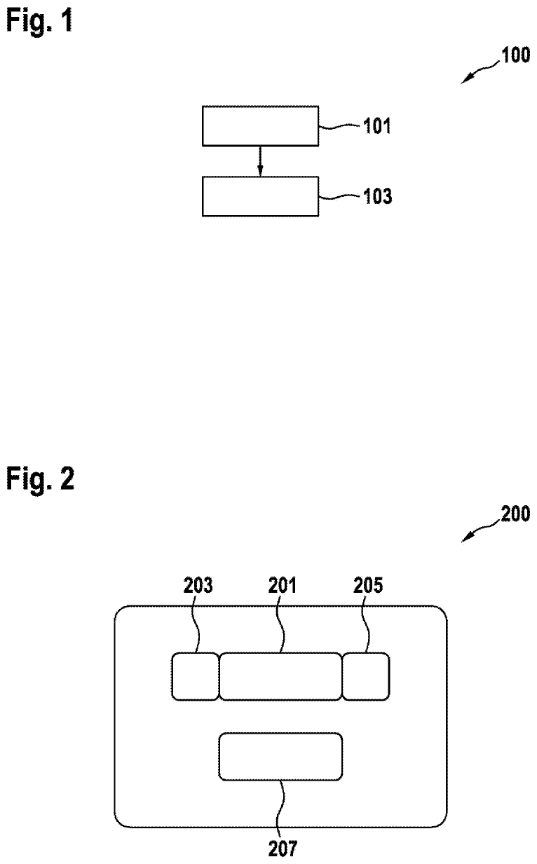

An operating method 100 for operating a fuel cell system is shown in FIG. 1. The operating method 100 comprises a detection step 101, in which a condition of the fuel cell system is detected, during which anode depletion occurs. To this end, for example, a curve of an electric current or a load demand provided by the fuel cell system can be analyzed and compared with a predetermined threshold.

In the event that a condition is detected in the detection step 101, in which anode depletion typically occurs, such as a −300 A/s change in the electric current provided or a load jump of −300 A, hydrogen is supplied to the anode subsystem of the fuel cell system by means of, for example, activating a hydrogen metering valve of the fuel cell system and/or a purge valve of the fuel cell system.

FIG. 2 shows a fuel cell system 200. The fuel cell system 200 comprises a fuel cell stack 201 with an anode subsystem 203 and a cathode subsystem 205, as well as computing unit 207.

The computing unit 207 is configured to perform the operating method 100 and may be, for example, a computer, a processor, a controller, or any other programmable circuitry.

1. A method for preventing anode depletion when operating a fuel cell system, the method comprising:
based on a change in an electric current which is provided to set a load demand that is reduced in comparison to a currently set load demand, determining, via a computer, a threshold for a characteristic value of an operating variable of the fuel cell system, and
increasing a hydrogen content in an anode subsystem of the fuel cell system when the characteristic value reaches the threshold.

2. The method according to claim 1,
wherein
the change in the electric current, which is provided in order to set the reduced load demand, is determined based on a change in the electric current over time and/or an absolute change in an amplitude of the electric current.

3. The method according to claim 1,
wherein
the threshold has a negative value, a positive value, or is formulated as an amount.

4. The operating method according to claim 1,
wherein
the characteristic value comprises a change in the electric current over time, a change in a pressure in a hydrogen system of the fuel cell system over time, and/or a change in a pressure in an air system of the fuel cell system over time.

5. The method according to claim 1,
wherein
the hydrogen content in the anode subsystem of the fuel cell system is increased by metering hydrogen into the anode system by way of a hydrogen metering valve and a purge valve is opened for releasing gas from the anode subsystem and/or an electric load of the fuel cell system is reduced, and/or a drop in a pressure in a cathode subsystem of the fuel cell system is delayed.

6. The method according to claim 1,
wherein
the hydrogen content in the anode subsystem of the fuel cell system is increased by closing a recirculation valve of the fuel cell system.

7. The method according to claim 1,
wherein
the hydrogen content in the anode subsystem is reduced back to a predetermined normal value when any of the following conditions occur:
since increasing the hydrogen content in the anode subsystem, a predetermined time has passed,
to increase the hydrogen content in the anode subsystem, a predetermined minimum amount of hydrogen was metered,
a hydrogen partial pressure in the anode subsystem is above a predetermined hydrogen partial pressure threshold.

8. The method according to claim 7,
wherein
the hydrogen partial pressure in the anode subsystem is estimated using a mathematical model.

9. A fuel cell system for converting energy,
wherein the fuel cell system comprises the following:
a fuel cell stack,
a computer,
wherein the computer is configured to
based on a change in an electric current which is provided to set a load demand that is reduced in comparison to a currently set load demand, determine a threshold for a characteristic value of an operating variable of the fuel cell system, and
control an increase in hydrogen content in an anode subsystem of the fuel cell system when the characteristic value reaches the threshold.

10. (canceled)
